(19) United States
(12) Patent Application Publication
(10) Pub. No.: US 2008/0044716 A1
(43) Pub. Date: Feb. 21, 2008

(54) DURABLE LAYER STRUCTURE AND METHOD FOR MAKING SAME

(75) Inventors: Mahmoud H. Abd Elhamid, Grosse Pointe Woods, MI (US); Gayatri Vyas, Rochester Hills, MI (US); Youssef M. Mikhail, Sterling Heights, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/464,844

(22) Filed: Aug. 16, 2006

(51) Int. Cl. H01M 8/02; B05D 1/36; B05D 5/12

(52) U.S. Cl. 429/38; 427/115; 427/402; 427/419.2

(57) ABSTRACT

A bipolar plate for a fuel cell that includes a hydrophilic layer deposited on the bipolar plate to a suitable thickness to satisfy hydrofluoric acid etching for the desired lifetime of the fuel cell. In one embodiment, the hydrophilic layer is a relatively thick silicon dioxide layer that is deposited on the bipolar plate as a colloidal dispersion of silicon dioxide nano-particles in a solvent. The dispersion is dried so that the solvent evaporates to form a film of the silicon dioxide nano-particles on the bipolar plate. A relatively thin layer, generally a metal oxide, is first deposited on the bipolar plate by a CVD or PVD process so that the thin layer has suitable bonding to the bipolar plate. The thicker hydrophilic layer is then deposited on the thin layer, where the bonds between the thick layer and the thin layer are suitable for the fuel cell environment.

### BACKGROUND OF THE INVENTION

1. Field of the Invention

This invention relates generally to bipolar plates for fuel cells and, more particularly, to a bipolar plate for a fuel cell that includes a thin metal oxide layer deposited on the bipolar plate by a process that provides suitable adhesion between the thin layer and the bipolar plate and a thick hydrophilic layer deposited on the thin layer by a process that provides suitable adhesion between the thick layer and the thin layer.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs require certain conditions for effective operation, including proper water management and humidification.

Several fuel cells are typically combined in a fuel cell stack to generate the desired power. For the automotive fuel cell stack mentioned above, the stack may include about two hundred or more fuel cells. The fuel cell stack receives a cathode reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack.

The fuel cell stack includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

The bipolar plates are typically made of a conductive material, such as stainless steel, titanium, aluminum, polymeric carbon composites, etc., so that they conduct the electricity generated by the fuel cells from one cell to the next cell and out of the stack. Metal bipolar plates typically produce a natural oxide on their outer surface that makes them resistant to corrosion. However, the oxide layer is not conductive, and thus increases the internal resistance of the fuel cell, reducing its electrical performance. Also, the oxide layer makes the plate more hydrophobic.

As is well understood in the art, the membranes within a fuel cell need to have a certain relative humidity so that the ionic resistance across the membrane is low enough to effectively conduct protons. During operation of the fuel cell, moisture from the MEAs and external humidification may enter the anode and cathode flow channels. At low cell power demands, typically below 0.2 A/cm², water accumulates within the flow channels because the flow rate of the reactant gas is too low to force the water out of the channels. As the water accumulates, it forms droplets that continue to expand because of the relatively hydrophobic nature of the plate material. The contact angle of the water droplets is generally about 80°-90° in that the droplets form in the flow channels substantially perpendicular to the flow of the reactant gas. As the size of the droplets increases, the flow channel is closed off, and the reactant gas is diverted to other flow channels because the channels are in parallel between common inlet and outlet manifolds. Because the reactant gas may not flow through a channel that is blocked with water, the reactant gas cannot force the water out of the channel. Those areas of the membrane that do not receive reactant gas as a result of the channel being blocked will not generate electricity, thus resulting in a non-homogenous current distribution and reducing the overall efficiency of the fuel cell. As more and more flow channels are blocked by water, the electricity produced by the fuel cell decreases, where a cell voltage potential less than 200 mV is considered a cell failure. Because the fuel cells are electrically coupled in series, if one of the fuel cells stops performing, the entire fuel cell stack may stop performing.

It is usually possible to purge the accumulated water in the flow channels by periodically forcing the reactant gas through the flow channels at a higher flow rate. However, on the cathode side, this increases the parasitic power applied to the air compressor, thereby reducing overall system efficiency. Moreover, there are many reasons not to use the hydrogen fuel as a purge gas, including reduced economy, reduced system efficiency and increased system complexity for treating elevated concentrations of hydrogen in the exhaust gas stream.

Reducing accumulated water in the channels can also be accomplished by reducing inlet humidification. However, it is desirable to provide some relative humidity in the anode and cathode reactant gases so that the membrane in the fuel cells remains hydrated. A dry inlet gas has a drying effect on the membrane that could increase the cell's ionic resistance, and limit the membrane's long-term durability.

It has been proposed in the art to make the bipolar plates for a fuel cell hydrophilic to improve channel water transport. A hydrophilic plate causes water in the channels to form a thin film that has less of a tendency to alter the flow distribution along the array of channels connected to the common inlet and outlet headers. If the plate material is sufficiently wettable, water transport through the diffusion media will contact the channel walls and then, by capillary force, be transported into the bottom corners of the channel along its length. The physical requirements to support spontaneous wetting in the corners of a flow channel are described by the Concus-Finn condition, β+α/2<90°, where β is the static contact angle and α is the channel corner angle. For a rectangular channel α/2=45°, which dictates that spontaneous wetting will occur when the static contact angle is less than 45°. For the roughly rectangular channels used in current fuel cell stack designs, this sets an approximate upper limit on the contact angle needed to realize the beneficial effects of hydrophilic plate surfaces on channel water transport and low load stability.

Hydrofluoric acid is produced in PEM fuel cells as a result of the degradation of the perfluorinated membrane. Hydrofluoric acid is a well known etchant that etches away silicon dioxide and other metal oxide coatings on bipolar plates. Therefore, these hydrophilic coatings need to be thick enough to meet the durability targets of the fuel cell stack before they are completely etched away, for example, 6000 hours. Current methods of depositing silicon dioxide and other hydrophilic coatings onto bipolar plates typically use chemical vapor deposition (CVD), physical vapor deposition (PVD) processes and plasma enhanced CVD, well known to those skilled in the art. However, such processes are relatively expensive when used to get the desired thickness to meet the durability target.

It has also been proposed in the art to deposit a colloidal dispersion of silicon dioxide (SiO₂) nano-particles in ethanol onto a bipolar plate substrate to make it hydrophilic. Commercially available materials including SiO₂ nano-particles dispersed in ethanol include X-tec HP4014/3408 provided by Nano-X Gmbh of Saarbrucken, Germany and Ludox from Dupont. Inexpensive techniques are known to deposit the silicon dioxide Nano-X on the plates, such as dipping, spraying and brushing, to a desirable thickness. The deposited coating is then dried or cured in a sol-gel type process to provide a film of the Nano-X on the bipolar plate as the ethanol is evaporated. However, it has been discovered that depositing hydrophilic coatings on metal substrates in this manner has poor adhesion to the metal, where the film typically becomes prematurely delaminated during operation of the fuel cell stack.

### SUMMARY OF THE INVENTION

In accordance with the teachings of the present invention, a bipolar plate for a fuel cell is disclosed that includes a hydrophilic layer deposited on the bipolar plate to a suitable thickness to satisfy hydrofluoric acid etching for the desired lifetime of the fuel cell. In one embodiment, the hydrophilic layer is a relatively thick silicon dioxide layer that is deposited on the bipolar plate as a colloidal dispersion of silicon dioxide nano-particles in a solvent. The dispersion is dried so that the solvent evaporates to form a film of the silicon dioxide nano-particles on the bipolar plate. A relatively thin layer, generally a metal, metal oxide, or an organic material with groups such as amines, sulphites, sulphates, thiols or carboxylates, is first deposited on the bipolar plate by a CVD or PVD process so that the thin layer has suitable bonding to the bipolar plate. The thick hydrophilic layer is then deposited on the thin layer, where the bonds between the thick layer and the thin layer are suitable to maintain layer adhesion in the fuel cell environment.

Additional features of the present invention will become apparent from the following description and appended claims, taken in conjunction with the accompanying drawings.

### BRIEF DESCRIPTION OF THE DRAWINGS

FIG. 1 is a cross-sectional view of a fuel cell in a fuel cell stack that includes a bipolar plate having a relatively thick hydrophilic layer and a relatively thin adhesion layer that causes the thick layer to adhere to the bipolar plate substrate, according to an embodiment of the present invention; and

FIG. 2 is an illustration of the bonding between the thick layer and the thin layer in the fuel cell shown on FIG. 1.

### DETAILED DESCRIPTION OF THE EMBODIMENTS

The following discussion of the embodiments of the invention directed to a bipolar plate for a fuel cell having a thick hydrophilic layer and a thin adhesion layer deposited on the bipolar plate is merely exemplary in nature, and is in no way intended to limit the invention or its applications or uses.

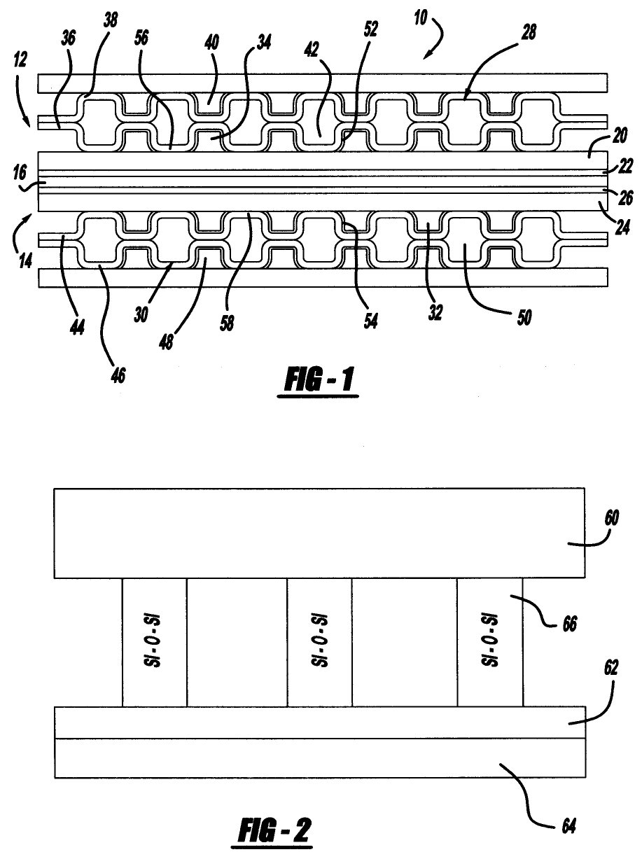

FIG. 1 is a cross-sectional view of a fuel cell 10 that is part of a fuel cell stack of the type discussed above. The fuel cell 10 includes a cathode side 12 and an anode side 14 separated by a perfluorosulfonic acid membrane 16. A cathode side diffusion media layer 20 is provided on the cathode side 12, and a cathode side catalyst layer 22 is provided between the membrane 16 and the diffusion media layer 20. Likewise, an anode side diffusion media layer 24 is provided on the anode side 14, and an anode side catalyst layer 26 is provided between the membrane 16 and the diffusion media layer 24. The catalyst layers 22 and 26 and the membrane 16 define an MEA. The diffusion media layers 20 and 24 are porous layers that provide for input gas transport to and water transport from the MEA. Various techniques are known in the art for depositing the catalyst layers 22 and 26 on the diffusion media layers 20 and 24, respectively, or on the membrane 16.

A cathode side flow field plate or bipolar plate 28 is provided on the cathode side 12 and an anode side flow field plate or bipolar plate 30 is provided on the anode side 14. The bipolar plates 28 and 30 are provided between the fuel cells in the fuel cell stack. A hydrogen reactant gas flow from flow channels 32 in the bipolar plate 30 reacts with the catalyst layer 26 to dissociate the hydrogen ions and the electrons. Airflow from flow channels 34 in the bipolar plate 28 reacts with the catalyst layer 22. The hydrogen ions are able to propagate through the membrane 16 where they carry the ionic current through the membrane 16. The end product is water, which does not have any negative impact on the environment.

In this non-limiting embodiment, the bipolar plate 28 includes two stamped metal sheets 36 and 38 that are welded together. The sheet 36 defines the flow channels 34 and the sheet 38 defines flow channels 40 for the anode side of an adjacent fuel cell to the fuel cell 10. Cooling fluid flow channels 42 are provided between the sheets 36 and 38, as shown. Likewise, the bipolar plate 30 includes a sheet 44 defining the flow channels 32, and a sheet 46 defining flow channels 48 for the cathode side of an adjacent fuel cell. Cooling fluid flow channels 50 are provided between the sheets 44 and 46, as shown. The bipolar plates 28 and 30 can be made of any suitable conductive material that can be stamped, such as stainless steel, titanium, aluminum, etc.

The bipolar plate 28 includes a layer 52 and the bipolar plate 30 includes a layer 54 that makes the plates conductive, corrosion resistant, hydrophilic and/or stable in a fuel cell environment. According to one embodiment of the present invention, the layers 52 and 54 are a film of a hydrophilic material that has been deposited on the bipolar plates by a Sol-gel process. Particularly, the layers 52 and 54 are deposited on the bipolar plates as a colloidal suspension of hydrophilic particles in a suitable solvent, such as ethanol. One non-limiting example is silicon dioxide nano-particles suspended in ethanol that is a commercially available product referred to as Nano-X. In an alternate embodiment, the colloidal suspension can include a conductive material, such as gold particles, that makes the layers 52 and 54 both hydrophilic and electrically conductive for the fuel cell environment. The colloidal suspension is deposited on the bipolar plates by a suitable low cost process, such as dipping the bipolar plate in the solution or spraying the solution on the bipolar plate. The bipolar plate is then allowed to dry or be cured so that the solvent evaporates to form a hydrophilic film on the bipolar plates.

As discussed above, the layers 52 and 54 can be a film of silicon dioxide (SiO₂) nano-particles. However, other metal oxides can be used for the hydrophilic layers including, but not limited to, titanium dioxide (TiO₂), hafnium dioxide (HfO₂), zirconium dioxide (ZrO₂), aluminum oxide (Al₂O₃), tin oxide (SnO₂), tantalum pent-oxide (Ta₂O₅), niobium pent-oxide (Nb₂O₅), molybdenum dioxide (MoO₂), iridium dioxide (IrO₂), ruthenium dioxide (RuO₂) and mixtures thereof.

The metal oxides can be doped to make them electrically conductive. Suitable dopants can be selected from materials that can create suitable point defects, such as N, C, Li, Ba, Pb, Mo, Ag, Au, Ru, Re, Nd, Y, Mn, V, Cr, Sb, Ni, W, Zr, Hf, etc. and mixtures thereof. In one particular embodiment, the doped metal oxide is niobium (Nb) and tantalum (Ta) doped titanium oxide (TiO₂) and fluorine (F) doped tin oxide (SnO₂). The amount of dopant in the coatings can be in the range of 0-10% of the composition of the coatings.

According to one embodiment of the present invention, the hydrophilic material is removed from the lands 56 and 58 between the flow channels 32 and 34, respectively, by any suitable process, such as sanding, so that the metal part of the bipolar plate is in electrical contact with the diffusion media layers so that electricity is effectively conducted through the fuel cell. Alternately, a masking process can be used to block the lands 56 and 58 when the layers are deposited on the bipolar plates.

As discussed above, the deposition of a thick hydrophilic dispersion on a metal substrate by Sol-gel processes typically has a poor adhesion of the hydrophilic film to the substrate. According to the invention, a thin inter-layer/adhesion promoter layer is first deposited on the bipolar plates 28 and 30 before the layers 52 and 54 to increase the adhesion of the layers 52 and 54 to the bipolar plate. FIG. 2 is an illustration of a thick hydrophilic layer 60, such as the Nano-X film, relative to a thin layer 62 deposited on a substrate 64, representing the bipolar plate 28 or 30. The thin layer 62 is deposited on the substrate 64 by a suitable process, such as CVD or PVD, that is known to provide good adhesion to a metal substrate by covalent bonds. Suitable examples of physical vapor deposition processes include electron beam evaporation, magnetron sputtering and pulse plasma processes. Suitable chemical vapor deposition processes include thermal CVD, plasma enhanced CVD and atomic layer deposition processes.

In one embodiment, the thin layer 62 is the same material as the hydrophilic material in the thick layer 62, such as silicon dioxide. When the thick layer 60 is deposited on the thin layer 62 by the Sol-gel process discussed above to provide the film, the thick layer 60 has good adhesion to the thin layer 62 through covalent bonding. For example, if the hydrophilic material in both the thick layer 60 and the thin layer 62 is silicon dioxide, then the material forms Si—O—Si covalent bonds 66. Particularly, the outside surface of the layers 60 and 62 are exposed to air and produce SiOH. When the outside surfaces of the layers 60 and 62 come in contact, the SiOH bond together to form Si—O—Si.

The thin layer 62 can be any suitable material for the purposes described herein. For example, if the thin layer were titanium dioxide, then the bonds between the thick layer 60 and the thin layer 62 would be Si—O—Ti. Other materials, such as ruthenium oxide can also be used.

According to another embodiment of the invention, the thin layer can be an organic material deposited on the plate substrate by a suitable process. Non-limiting examples of suitable organic materials include amines, sulphites, sulphates, thiols and carboxylates.

According to another embodiment of the present invention, the thin layer 62 is formed by modifying the surface of the stainless steel substrate. For example, a suitable metal, such as titanium (Ti), Zirconium (Zr), tantalum (Ta), halfnium (Hf), chromium (Cr), tungsten (W), iridium (Ir), ruthenium (Ru) and mixtures thereof, are deposited on the substrate. These layers are then oxidized to form oxides on the substrate that provide a suitable bond to the thick layer 60.

The layers 52 and 54 are deposited on the bipolar plates 28 and 30, respectively, to a thickness, such as in the range of 100 nm-1000 nm, so that the hydrofluoric acid etch that occurs during operation of the fuel cell will not completely etch away the layers 52 and 54 over the desired lifetime of the fuel cell. Particularly, hydrofluoric acid is generated as a result of degradation of the perfluorosulfonic ionomer in the membrane during operation of the fuel cell. The hydrofluoric acid has a corrosive effect on the bipolar plates that make them electro-chemically unstable.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell comprising a flow field plate being made of a plate material, said flow field plate including a plurality of flow channels responsive to a reactant gas, said flow field plate further including a thin layer deposited on the flow field plate by a process that bonds the thin layer to the plate material effective for a fuel cell environment and a thick layer deposited on the thin layer where the thick layer bonds to the thin layer, wherein the thick layer includes a hydrophilic material.

2. The fuel cell according to claim 1 wherein the plate material is selected from a group consisting of stainless steel, titanium, aluminum and a polymer-carbon based material.

3. The fuel cell according to claim 1 wherein the thick layer is deposited on the flow field plate as a dispersion of hydrophilic nano-particles in a solvent where the dispersion is dried to evaporate the solvent to a leave a film of the hydrophilic nano-particles.

4. The fuel cell according to claim 1 wherein the thick layer includes a metal oxide.

5. The fuel cell according to claim 4 wherein the thin layer includes a metal oxide.

6. The fuel cell according to claim 5 wherein the metal oxide for the thin layer and the thick layer is selected from the group consisting of silicon dioxide, titanium dioxide, halfnium dioxide, zirconium dioxide, aluminum oxide, tin oxide, tantalum pent-oxide, niobium pent-oxide, molybedum dioxide, iridium dioxide, ruthenium dioxide and mixtures thereof.

7. The fuel cell according to claim 1 wherein the thin layer is an organic material.

8. The fuel cell according to claim 7 wherein the organic material is selected from the group consisting of amines, sulphites, sulphates, thiols and carboxylates.

9. The fuel cell according to claim 1 wherein the thin layer is provided by a process of modifying a surface of the flow field plate by depositing a metal on the flow field plate and oxidizing the metal.

10. The fuel cell according to claim 9 wherein the metal is selected from the group consisting of titanium, zirconium, tantalum, halfnium, chromium, tungsten, iridium, ruthenium and mixtures thereof.

11. The fuel cell according to claim 1 wherein the fuel cell includes a perfluorinated ionomer membrane that produces hydrofluoric acid during fuel cell operation, and wherein the thickness of the thick layer is thick enough so that hydrofluoric acid etching of the thick layer during operation of the fuel cell does not completely etch away the thick layer for at least 6000 hours of operation of the fuel cell.

12. The fuel cell according to claim 1 wherein the thickness of the thick layer is in the 100 nm-1000 nm range and the thickness of the thin layer is in the 1 nm-10 nm range.

13. The fuel cell according to claim 1 wherein the flow field plate is selected from a group consisting of anode side flow field plates and cathode side flow field plates.

14. The fuel cell according to claim 1 wherein the thin layer is deposited on the flow field plate by a process selected from the group consisting of physical vapor deposition processes, chemical vapor deposition (CVD) processes, electron beam evaporation, magnetron sputtering, pulsed plasma processes, plasma enhanced CVD and atomic layer deposition processes.

15. The fuel cell according to claim 1 wherein the fuel cell is part of a fuel cell system on a vehicle.

16. A fuel cell comprising a perfluorinated ionomer membrane and a flow field plate being made of stainless steel, said flow field plate including a plurality of flow channels responsive to a reactant gas, said flow field plate further including a thin layer deposited on the flow field plate by a process that bonds the thin layer to the stainless steel effective for a fuel cell environment and a metal oxide thick layer deposited on the thin layer where the thick layer bonds to the thin layer, wherein the thick layer is deposited on the flow field plate as a dispersion of hydrophilic nano-particles in a solvent where the dispersion is dried to evaporate the solvent to a leave a film of the hydrophilic nano-particles, and wherein the perfluorinated ionomer membrane produces hydrofluoric acid during fuel cell operation, and wherein the thickness of the thick layer is thick enough so that hydrofluoric acid etching of the thick layer during operation of the fuel cell does not completely etch away the thick layer for at least 6000 hours of operation of the fuel cell.

17. The fuel cell according to claim 16 wherein the thin layer is a metal oxide.

18. The fuel cell according to claim 17 wherein the metal oxide for the thin layer and the thick layer is selected from the group consisting of silicon dioxide, titanium dioxide, halfnium dioxide, zirconium dioxide, aluminum oxide, tin oxide, tantalum pent-oxide, niobium pent-oxide, molybedum dioxide, iridium dioxide, ruthenium dioxide and mixtures thereof.

19. The fuel cell according to claim 16 wherein the thin layer is an organic material.

20. The fuel cell according to claim 19 wherein the organic material is selected from the group consisting of amines, sulphites, sulphates, thiols and carboxylates.

21. The fuel cell according to claim 16 wherein the thin layer is provided by a process of modifying a surface of the flow field plate by depositing a metal on the flow field plate and oxidizing the metal.

22. The fuel cell according to claim 21 wherein the metal is selected from the group consisting of titanium, zirconium, tantalum, halfnium, chromium, tungsten, iridium, ruthenium and mixtures thereof.

23. The fuel cell according to claim 16 wherein the thickness of the thick layer is in the 100 nm-1000 nm range and the thickness of the thin layer is in the 1 nm-10 nm range.

24. The fuel cell according to claim 16 wherein the flow field plate is selected from a group consisting of anode side flow field plates and cathode side flow field plates.

25. The fuel cell according to claim 16 wherein the thin layer is deposited on the flow field plate by a process selected from the group consisting of physical vapor deposition processes, chemical vapor deposition (CVD) processes, electron beam evaporation, magnetron sputtering, pulsed plasma processes, plasma enhanced CVD and atomic layer deposition processes.

26. The fuel cell according to claim 16 wherein the fuel cell is part of a fuel cell system on a vehicle.

27. A method for providing a flow field plate for a fuel cell, said method comprising:
providing a flow field plate substrate;
depositing a thin layer on the bipolar plate substrate by a process that bonds the thin layer to the substrate effective for a fuel cell environment; and
depositing a thick layer on the thin layer by a process that bonds the thick layer to the thin layer, where the thick layer includes a hydrophilic material.

28. The method according to claim 27 wherein providing a flow field plate substrate includes providing a stainless steel flow field plate substrate.

29. The method according to claim 27 wherein depositing the thick layer includes depositing the thick layer as a dispersion of hydrophilic nano-particles in a solvent where the dispersion is dried to evaporate the solvents to leave a film of the hydrophilic nano-particles in a sol-gel type process.

30. The method according to claim 27 wherein depositing the thick layer includes depositing a metal oxide.

31. The method according to claim 30 wherein depositing the thin layer includes depositing a metal oxide.

32. The method according to claim 31 wherein the metal oxide for the thin layer and the thick layer is selected from the group consisting of silicon dioxide, titanium dioxide, halfnium dioxide, zirconium dioxide, aluminum oxide, tin oxide, tantalum pent-oxide, niobium pent-oxide, molybedum dioxide, iridium dioxide, ruthenium dioxide and mixtures thereof.

33. The method according to claim 27 wherein depositing the thin layer includes depositing an organic material.

34. The method according to claim 33 wherein the organic material is selected from the group consisting of amines, sulphites, sulphates, thiols and carboxylates.

35. The method according to claim 27 wherein depositing the thin layer includes depositing a metal on the flow field plate and oxidizing the metal.

36. The method according to claim 35 wherein the metal is selected from the group consisting of titanium, zirconium, tantalum, halfnium, chromium, tungsten, iridium, ruthenium and mixtures thereof.

37. The method according to claim 27 wherein depositing the thin layer includes depositing the thin layer by a process selected from the group consisting of physical vapor deposition processes, chemical vapor deposition processes, thermal spraying processes, electron beam evaporation, magnetron sputtering, pulsed plasma processes, plasma enhanced chemical vapor deposition and atomic layer deposition processes.

38. The method according to claim 27 wherein depositing the thin layer and the thick layer includes depositing the thin layer to a thickness in the range of 1 nm-110 nm and depositing the thick layer in the range of 100 nm-1000 nm.
